(19) United States
(12) Patent Application Publication
(10) Pub. No.: US 2009/0305890 A1
(43) Pub. Date: Dec. 10, 2009

(54) METHOD OF CONTROLLING PLANTS

(75) Inventors: Andrew Lawrence Patrick Cairns, Berkshire (GB); Mark Andrew Spinney, Berkshire (GB)

Correspondence Address: SYNGENTA CROP PROTECTION , INC.;PATENT AND TRADEMARK DEPARTMENT, 410 SWING ROAD, GREENSBORO, NC, 27409, US

(73) Assignee: SYNGENTA LIMITED, Guildford, Surrey (GB)

(21) Appl. No.: 12/066,687

(22) PCT Filed: Sep. 12, 2006
(86) PCT No.: PCT/GB2006/003377

§ 371 Date: Jul. 16, 2008

(30) Foreign Application Priority Data
Sep. 16, 2005 (ZA) 2005/07471
Oct. 12, 2005 (ZA) 2005/08238

(51) Int. Cl. A01N 57/10; A01N 43/40; A01P 13/00

(52) U.S. Cl. 504/128; 504/130

(57) ABSTRACT

A method of controlling plants that are resistant to paraquat or glufosinate, the method comprising applying to the plants or to a locus of the plants a synergistic combination of a PS1 inhibitor and glutamine synthetase inhibitor.

This invention relates to a method of controlling plants, particularly herbicide resistant plants.

Undesirable plants or weeds represent a major problem to farmers because the weeds compete for light, nutrients and water with a crop being cultivated. If not controlled, weeds can reduce the yield of the crop by a considerable margin which can have a serious impact on a farmer's profits.

The weed problem has stimulated research into the development of chemical herbicides. A wide range of herbicides have been developed and are in widespread commercial use. These are usually applied to cultivated lands by spraying. Generally these represent a satisfactory solution to the weed problem. However, when a particular herbicide is repeatedly applied in a particular area, a further problem can arise if the weed population in that area evolves resistance to the herbicide. Resistance can mean that the effectiveness of the herbicide is reduced or, in extreme cases, it is rendered wholly ineffective.

One of the most widely used non-selective herbicides in the world is paraquat. A major producer of this product is Syngenta which sells it under the trade name of “Gramoxone”. Paraquat came on the market in the early '60s and dominated the non-selective herbicide market for many years. Weed resistance to paraquat has evolved to a limited extent, mostly in the Conyza genus, but so far has never assumed much economic significance. Another major commercial non-selective herbicide is glufosinate. As yet, glufosinate resistance has not emerged to a significant extent, but there is clearly a danger that resistance will emerge in the future.

Although paraquat resistance and glufosinate resistance are not yet major commercial problems, it is very important to develop tools to reduce the rate of resistance evolution and to provide alternatives for the suppression of resistant biotypes now and in the future. In accordance with the present invention there is provided a method of controlling plants that are resistant to paraquat or glufosinate, the method comprising applying to the plants a synergistic combination of a herbicide which is a photosystem 1 inhibitor and a herbicide which is a glutamine synthetase inhibitor.

Examples of photosystem 1 inhibitors (PS1 inhibitors) are salts of paraquat, salts of diquat and salts of difenzoquat. Preferably the PS1 inhibitor is a salt of paraquat. Paraquat is the common name of the 1,1′-dimethyl-4,4′-bipyridylium cation. Salts of paraquat contain anions having sufficient negative charges to balance the two positive charges on each paraquat cation. The herbicidal effect of the paraquat cation is largely independent of the identity of the associated anion. Thus the anion can be chosen on a cost or convenience basis. Preferably the anion is chosen to give a salt of convenient water solubility. Examples of anions, which may be mono, or polyvalent include acetate, benzenesulfonate, benzoate, bromide, butyrate, chloride, citrate, fluorosilicate, fumarate, lactate, maleate, propionate, phosphate, succinate, sulphate, thiocyanate and tartrate. Paraquat is normally sold as paraquat dichloride.

Examples of glutamine synthetase inhibitors are glufosinate and bialophos, preferably glufosinate. Glufosinate is generally in the form of a salt and preferably it is glufosinate ammonium, although other salts could be used. Glufosinate ammonium is the common name of ammonium 4-[hydrox(methyl)phosphinoyl]-DL-homoalaninate.

‘Synergistic’ means a combination of PS1 inhibitor and glutamine synthetase inhibitor that can be used to control plants that are resistant to paraquat or glufosinate more effectively that would be expected from the effects of the individual components alone. Such synergy is entirely unexpected. The present invention thus provides an important resistance management tool for farmers who may experience weeds resistant to paraquat or glufosinate. The mixture can be used to clean-up outbreaks of resistant weeds or as part of an ongoing weed control management programme to delay the development of resistance in weed populations.

‘Controlling’ plants means killing them, inhibiting or stunting their growth or inhibiting or preventing the germination of their seeds.

‘Resistant’ means that the plant is less well controlled by applying the same level of herbicide than an equivalent typical wild-type plant of the same species and growth stage. The term ‘resistant to paraquat or glufosinate’ embraces plants that are resistant to one or both of these herbicides. The invention is particularly useful for the control of plants that are resistant to paraquat.

‘Plants’ include any plants for which control is desired, including species commonly regarded as weeds. It also includes species that may be crop plants which are growing where they are not wanted, such as out of the crop area (‘escapes’) or in an area where a different crop is being, or will be, grown (‘volunteers’).

The method can be used in traditional ‘burn-down’ applications for removing all plants from a particular area, especially as part of ‘minimum tillage’ farming practices designed to minimise soil erosion or in tree plantations for clearing between the trees. It can also be used in conjunction with the planting of crops that are tolerant to herbicides, such as glyphosate-tolerant corn, soybeans and cotton, and glufosinate-tolerant corn.

The PS1 inhibitor and glutamine synthetase inhibitor can be applied sequentially, for example a number of hours or days apart, such as up to 15 days apart. In this case, preferably the glutamine synthetase inhibitor is applied first. Alternatively and preferably they can be applied simultaneously in a single herbicidal composition.

Preferably the PS1 inhibitor is applied at a rate of between 5 and 5000 g/ha, more preferably between 10 and 4000 g/ha. Preferred practical rates of paraquat are between 100 and 1000 g/ha, based on the weight of paraquat anion. Preferably the glutamine synthetase inhibitor is applied at a rate of 25 to 1000 g/ha, more preferably 50 to 700 g/ha. Preferred practical rates of glufosinate are between 100 and 1000 g/ha, based on the weight of glufosinate ammonium.

Preferably the weight ratios of the PS1 inhibitor and the glutamine synthetase inhibitor is the range 1:10 to 10:1.

The herbicidal composition can be chosen from a number of formulation types, including soluble concentrates (SL), oil miscible liquids (OL), ultra low volume liquids (UL), emulsifiable concentrates (EC), dispersible concentrates (DC), emulsions (both oil in water (EW) and water in oil (EO)), micro-emulsions (ME), suspension concentrates (SC) and capsule suspensions (CS).

Emulsifiable concentrates (EC) or oil-in-water emulsions (EW) may be prepared by dissolving the PS1 inhibitor and glutamine synthetase inhibitor in an organic solvent (optionally containing one or more wetting agents, one or more emulsifying agents or a mixture of said agents). Suitable organic solvents for use in ECs include aromatic hydrocarbons (such as alkylbenzenes or alkylnaphthalenes, exemplified by SOLVESSO 100, SOLVESSO 150 and SOLVESSO 200; SOLVESSO is a Registered Trade Mark), ketones (such as cyclohexanone or methylcyclohexanone) and alcohols (such as benzyl alcohol, furfuryl alcohol or butanol),

N-alkylpyrrolidones (such as N-methylpyrrolidone or N-octylpyrrolidone), dimethyl amides of fatty acids (such as C₈-C₁₀ fatty acid dimethylamide) and chlorinated hydrocarbons. An EC product may spontaneously emulsify on addition to water, to produce an emulsion with sufficient stability to allow spray application through appropriate equipment. Preparation of an EW involves obtaining the PS1 inhibitor and glutamine synthetase inhibitor either as a solution (by dissolving it in an appropriate solvent) and then emulsifiying the resultant liquid or solution into water containing one or more surfactants, under high shear, to produce an emulsion. Suitable solvents for use in EWs include vegetable oils, chlorinated hydrocarbons (such as chlorobenzenes), aromatic solvents (such as alkylbenzenes or alkylnaphthalenes) and other appropriate organic solvents which have a low solubility in water.

Dispersible Concentrates (DC) may be prepared by dissolving the PS1 inhibitor and glutamine synthetase inhibitor in water or an organic solvent, such as a ketone, alcohol or glycol ether. These solutions may contain a surface active agent (for example to improve water dilution or prevent crystallisation in a spray tank).

Microemulsions (ME) may be prepared by mixing water with a blend of one or more solvents with one or more surfactants, to produce spontaneously a thermodynamically stable isotropic liquid formulation. The PS1 inhibitor and glutamine synthetase inhibitor are present initially in either the water or the solvent/surfactants blend. Suitable solvents for use in MEs include those hereinbefore described for use in ECs or in EWs. An ME may be either an oil-in-water or a water-in-oil system (which system is present may be determined by conductivity measurements) and may be suitable for mixing water-soluble and oil-soluble pesticides in the same formulation. An ME is suitable for dilution into water, either remaining as a microemulsion or forming a conventional oil-in-water emulsion.

Suspension concentrates (SC) may comprise aqueous or non-aqueous suspensions of finely divided insoluble solid particles of the PS1 inhibitor and glutamine synthetase inhibitor. SCs may be prepared by ball or bead milling the solid compound of formula (I) in a suitable medium, optionally with one or more dispersing agents, to produce a fine particle suspension of the compound. One or more wetting agents may be included in the composition and a suspending agent may be included to reduce the rate at which the particles settle.

Capsule suspensions (CS) may be prepared in a manner similar to the preparation of EW formulations but with an additional polymerisation stage such that an aqueous dispersion of oil droplets is obtained, in which each oil droplet is encapsulated by a polymeric shell and contains PS1 inhibitor and glutamine synthetase inhibitor and, optionally, a carrier or diluent therefor. The polymeric shell may be produced by either an interfacial polycondensation reaction or by a coacervation procedure. The compositions may provide for controlled release of the paraquat and glufosinate ammonium. The PS1 inhibitor and glutamine synthetase inhibitor may also be formulated in a biodegradable polymeric matrix to provide a slow, controlled release of the compounds.

A composition may include one or more additives to improve the biological performance of the composition (for example by improving wetting, retention or distribution on surfaces; resistance to rain on treated surfaces; or uptake or mobility of PS1 inhibitor and glutamine synthetase inhibitor. Such additives include surface active agents, spray additives based on oils, for example certain mineral oils or natural plant oils (such as soy bean and rape seed oil), ammonium sulphate, and blends of these with other bio-enhancing adjuvants (ingredients which may aid or modify the action of the PS1 inhibitor and glutamine synthetase inhibitor).

Wetting agents, dispersing agents and emulsifying agents may be surfactants of the cationic, anionic, amphoteric or non-ionic type.

Suitable cationic surfactants include quaternary ammonium compounds (for example cetyltrimethyl ammonium bromide), imidazolines and amine salts.

Suitable anionic surfactants include alkali metals salts of fatty acids, salts of aliphatic monoesters of sulphuric acid (for example sodium lauryl sulphate), salts of sulphonated aromatic compounds (for example sodium dodecylbenzenesulphonate, calcium dodecylbenzenesulphonate, butylnaphthalene sulphonate and mixtures of sodium di-isopropyl- and tri-isopropyl-naphthalene sulphonates), ether sulphates, alcohol ether sulphates (for example sodium laureth-3-sulphate), ether carboxylates (for example sodium laureth-3-carboxylate), phosphate esters (products from the reaction between one or more fatty alcohols and phosphoric acid (predominately mono-esters) or phosphorus pentoxide (predominately di-esters), for example the reaction between lauryl alcohol and tetraphosphoric acid; additionally these products may be ethoxylated), sulphosuccinamates, paraffin or olefin sulphonates, taurates and lignosulphonates.

Suitable amphoteric surfactants include betaines, propionates and glycinates.

Suitable non-ionic surfactants include condensation products of alkylene oxides, such as ethylene oxide, propylene oxide, butylene oxide or mixtures thereof, with fatty alcohols (such as oleyl alcohol or cetyl alcohol) or with alkylphenols (such as octylphenol, nonylphenol or octylcresol); partial esters derived from long chain fatty acids or hexitol anhydrides; condensation products of said partial esters with ethylene oxide; block polymers (comprising ethylene oxide and propylene oxide); alkanolamides; simple esters (for example fatty acid polyethylene glycol esters); amine oxides (for example lauryl dimethyl amine oxide); and lecithins.

Suitable suspending agents include hydrophilic colloids (such as polysaccharides, polyvinylpyrrolidone or sodium carboxymethylcellulose), silicas, microcrystalline cellulose and clays.

The composition can be formulated so as to have a safened effect against ingestion, such as the formulations disclosed in patent application WO02/076212.

The composition may be applied by any of the known means of applying herbicides. Typically, they are sprayed, formulated or unformulated directly to the plants or to any part of the plant, including the foliage, stems, branches or roots, or to other media in which the plants are growing (such as paddy water or hydroponic culture systems). The sprayer can be hand-held or tractor-mounted.

The compositions can also comprise additional herbicides to potentiate the foliar action of the mixture and/or provide extended weed control through a residual action. These can be conveniently selected from the large number of commercial and development herbicides available and known. Examples of specific additional herbicides are PPO-inhibiting herbicides such as acifluorofen, bromoxynil, butafenacil, carfentrazone, flumioxazin, lactofen, oxyfluorofen, pyraflufen-ethyl, sulfentrazone, fomesafen, the compound of structure;

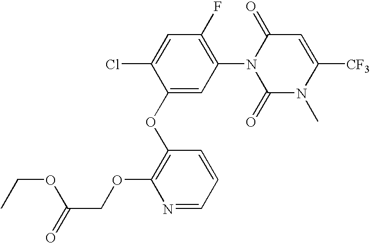

and the compound of structure;

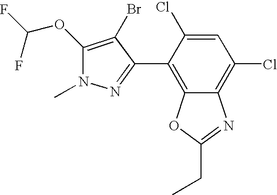

and PS2 inhibitors such as ametryne, atrazine, diuron, monolinuron, terbuthylazine, simazine and prometryne.

### EXAMPLES

The weights of paraquat refer to the weight of paraquat anion. The weights of glufosinate ammonium relate to the weight of glufosinate ammonium salt.

### Example 1

Aqueous herbicidal compositions comprising water and paraquat alone at various application rates, glufosinate ammonium alone at various application rates and compositions containing water and combinations of these two herbicides were applied over certain paraquat resistant plants. Ammonium sulphate was included in all of the compositions at a concentration of 1% w/v. The effectiveness of the composition in controlling the plants was assessed visually 14 days after applying the herbicide. The assessment was made as a percentage control −0% representing no damage and 100% representing death of all the plants. The plants used were two paraquat resistant Lolium biotypes (referred to as RL 1 and RL 2, collected in South Africa). The plants were grown in a greenhouse to the two-three true leaves stage before the herbicide was applied. Three replicates of each treatment were carried out.

The results were analysed using the Colby formula which generates an expected level of control from the results obtained by using the individual components alone. This was compared with the actual level of control. The Colby formula predicts that the expected percentage level of control E for a particular combination of components is obtained as follows, in which P1 and P2 are the levels of control obtained by using the components alone

E=P1+P2−{P1·P2/100}.

The average percentage control results for the three replicates are given in Table 1. The figures given in the Synergy column in the table below are the difference between the predicted level of control and the actual level of control. A figure of zero means that the actual result is as predicted by the Colby equation. Any number above zero represents evidence of synergy. Numbers below zero may represent antagonism.

TABLE 1

| | | | | | |
|---|---|---|---|---|---|
| | | Average | | Average | |
| | Glufosinate | % | | % | |
| Paraquat | ammonium | control of | Synergy | control of | Synergy |
| g/ha | g/ha | RL 1 | for RL 1 | RL 2 | for RL 2 |

Results for paraquat alone

| | | | | | |
|---|---|---|---|---|---|
| 10 | n/a | 0 | — | 0 | — |
| 20 | n/a | 0 | — | 0 | — |
| 60 | n/a | 0 | — | 0 | — |
| 80 | n/a | 17 | — | 0 | — |
| 400 | n/a | 33 | — | 0 | — |
| 1200 | n/a | 33 | — | 7 | — |
| 2000 | n/a | 98 | — | 3 | — |
| 4000 | n/a | 100 | — | 42 | — |

Results for glufosinate ammonium alone

| | | | | | |
|---|---|---|---|---|---|
| n/a | 50 | 0 | — | 0 | — |
| n/a | 100 | 0 | — | 0 | — |
| n/a | 200 | 3 | — | 2 | — |
| n/a | 400 | 2 | — | 33 | — |
| n/a | 600 | 78 | — | 89 | — |

Results for mixtures

| | | | | | |
|---|---|---|---|---|---|
| 10 | 50 | 0 | 0 | 0 | 0 |
| 10 | 100 | 0 | 0 | 2 | 2 |
| 10 | 200 | 2 | −2 | 0 | −2 |
| 10 | 400 | 99 | 98 | 65 | 32 |
| 10 | 600 | 47 | −32 | 98 | 9 |
| 20 | 50 | 0 | 0 | 0 | 0 |
| 20 | 100 | 0 | 0 | 0 | 0 |
| 20 | 200 | 2 | −2 | 0 | −2 |
| 20 | 400 | 58 | 56 | 93 | 60 |
| 20 | 600 | 81 | 3 | 96 | 7 |
| 60 | 50 | 0 | 0 | 0 | 0 |
| 60 | 100 | 0 | 0 | 0 | 0 |
| 60 | 200 | 23 | 20 | 0 | −2 |
| 60 | 400 | 73 | 71 | 92 | 59 |
| 60 | 600 | 68 | −10 | 68 | −21 |
| 80 | 50 | 45 | 28 | 0 | 0 |
| 80 | 100 | 37 | 20 | 2 | 2 |
| 80 | 200 | 12 | −8 | 35 | 33 |
| 80 | 400 | 91 | 73 | 90 | 57 |
| 80 | 600 | 48 | −34 | 96 | 7 |
| 400 | 50 | 67 | 33 | 2 | 2 |
| 400 | 100 | 67 | 33 | 2 | 2 |
| 400 | 200 | 82 | 46 | 2 | 0 |
| 400 | 400 | 80 | 46 | 55 | 22 |
| 400 | 600 | 83 | −2 | 80 | −9 |
| 1200 | 50 | 5 | −28 | 2 | −5 |
| 1200 | 100 | 93 | 60 | 2 | −5 |
| 1200 | 200 | 97 | 61 | 10 | 2 |
| 1200 | 400 | 100 | 66 | 78 | 41 |
| 1200 | 600 | 100 | 14 | 42 | −48 |
| 2000 | 50 | 97 | −2 | 71 | 68 |
| 2000 | 100 | 72 | −27 | 5. | 2 |
| 2000 | 200 | 100 | 2 | 75 | 70 |
| 2000 | 400 | 98 | 0 | 40 | 5 |
| 2000 | 600 | 100 | 0 | 85 | −5 |
| 4000 | 50 | 100 | 0 | 90 | 48 |
| 4000 | 100 | 100 | 0 | 60 | 18 |
| 4000 | 200 | 100 | 0 | 95 | 52 |
| 4000 | 400 | 100 | 0 | 73 | 12 |
| 4000 | 600 | 100 | 0 | 100 | 6 |

### Example 2

A glasshouse study was conducted with two biotypes of ryegrass (Lolium rigidum), one paraquat resistant and the other paraquat susceptible. The plants (3 leaf stage) were planted in pots at a density of approximately 14,000 plants/m² to simulate field infestation levels. The treatments were based on commercial formulations of paraquat and glufosinate were diluted in water including the adjuvants AMS (5%) and Agral 90 (0.25%). The treatments were applied to the plants in a spray volume equivalent to 400 lts/ha. Each treatment was replicated three times. The effectiveness of the treatments in controlling the plants was assessed visually 28 days after applying the herbicide. The assessment was made as a percentage control −0% representing no damage and 100% representing death of all the plants. The results are shown in Table 2.

TABLE 2

| | |
|---|---|
| Composition and rate of application | Percentage Control |

Paraquat Susceptible Population

| | |
|---|---|
| Untreated Control | 0% |
| Paraquat 600 g ai/ha | 100% |
| Glufosinate 300 g ai/ha | 85% |
| Paraquat 600 g ai/ha + glufosinate 300 g ai/ha | 100% |

Paraquat Resistant Population

| | |
|---|---|
| Untreated Control | 0% |
| Paraquat 600 g ai/ha | 29% |
| Glufosinate 300 g ai/ha | 44% |
| Paraquat 600 g ai/ha + glufosinate 300 g ai/ha | 99% |

### Example 3

A glasshouse test was conducted to examine the effect of applying the products sequentially (ie. in a split application), using paraquat resistant ryegrass (Lolium rigidum) plants. The plants were planted in pots and at the time of the initial application they were at the 4½ leaf stage. The treatments were based on commercial formulations of paraquat and glufosinate were diluted in water including the adjuvants AMS (5%) and Agral 90 (0.25%). The treatments' were applied to the plants in a spray volume equivalent to 400 lts/ha. Each treatment was replicated 3 times. The effectiveness of the treatments in controlling the plants was assessed visually 28 days after the initial application date. The assessment was made as a percentage control −0% representing no damage and 100% representing death of all the plants. The results are shown in Table 3.

TABLE 3

| Composition | Rate of application | % Control |
|---|---|---|
| Paraquat | 600 g ai/ha | 58% |
| Glufosinate | 150 g ai/ha | 0% |
| Glufosinate | 200 g a/ha | 33% |
| Glufosinate | 300 g ai/ha | 83% |

Glufosinate applied and then paraquat applied 4 days later.

| | | |
|---|---|---|
| Glufosinate + paraquat | 150 g ai/ha + 600 g/ai ha | 100% |
| Glufosinate + paraquat | 200 g ai/ha + 600 g/ai ha | 100% |
| Glufosinate + paraquat | 300 g ai/ha + 600 g/ai ha | 100% |

1. A method of controlling plants that are resistant to paraquat or glufosinate, the method comprising applying to the plants a synergistic combination of a photosystem 1 inhibitor and glutamine synthetase inhibitor.

2. A method as claimed in claim 1 in which the PS1 inhibitor and glutamine synthetase inhibitor are applied sequentially.

3. A method as claimed in claim 1 in which the photosystem 1 inhibitor and glutamine synthetase inhibitor are applied simultaneously in a single herbicidal composition.

4. A method as claimed in claim 1 in which the photosystem 1 inhibitor is a salt of paraquat.

5. A method as claimed in claim 4 in which the salt of paraquat is applied at a rate of between 5 and 5000 g/ha

6. A method as claimed in claim 5 in which the salt of paraquat is applied at a rate of between 10 and 4000 g/ha.

7. A method as claimed in claim 1 in which the glutamine synthetase inhibitor is glufosinate ammonium.

8. A method as claimed in claim 7 in which the glufosinate ammonium is applied at a rate of 25 to 100 g/ha.

9. A method as claimed in claim 8 in which the glufosinate ammonium is applied at a rate of 50 to 700 g/ha.

10. A method as claimed in claim 1 in which the composition comprises an additional herbicide.

11. A method as claimed in claim 1 used to control paraquat-resistant plants.
